(19) United States
(12) Patent Application Publication
(10) Pub. No.: US 2015/0284664 A1
(43) Pub. Date: Oct. 8, 2015

(54) Dishwashing Detergent Composition Comprising Soapwort Extract

(71) Applicant: RECKITT BENCKISER N.V., Hoofddorp (NL)

(72) Inventors: Judith Preuschen, Ludwigshafen (DE); Marine Cabirol, Dusseldorf (DE); Lucia Krubasik, Ludwigshafen (DE); Dietmar Van Loyen, Ludwigshafen (DE)

(21) Appl. No.: 14/434,052

(22) PCT Filed: Oct. 18, 2013
(86) PCT No.: PCT/GB2013/052728

§ 371 Date: Apr. 7, 2015

(30) Foreign Application Priority Data
Oct. 19, 2012 (GB) 1218835.5

(51) Int. Cl. C11D 3/382; A47L 15/00; B08B 3/08; C11D 3/22

(52) U.S. Cl. CPC C11D 3/382; C11D 3/221; A47L 15/0018; B08B 3/08

(57) ABSTRACT

The invention relates to a detergent composition that comprises a soapwort extract that is formulated to provide effective cleaning at low temperatures.

The invention relates to detergent compositions. In particular it relates to detergent compositions that contain an extract from the soapwort plant and are effective at low temperature. Preferably these detergent compositions are formulated as automatic dishwashing (ADW) detergent compositions.

The current trend in automatic dishwashing is to improve the environmental impact of the cleaning process. This has manifested itself mainly in three ways, firstly by the use of less water during the cleaning cycle, secondly by the reduction of the use of phosphates in the detergent compositions and thirdly by the reduction in energy consumption of the machines during the cleaning cycle.

The latter trend has lead to new machines that are increasingly offering wash programs using lower cleaning and drying temperature settings than have historically been used. Where previously, ten years ago, an economy wash may have been carried out at 55° C., now there are commercially available dishwashing machines that offer programs at temperatures as low as 45° C. and even 40° C.

This drop in wash temperature raises a number of different technical challenges for the manufacturers of detergent formulations to maintain cleaning performance at these lower temperatures.

One of the issues is the cleaning of fats from soiled tableware. Currently animal and vegetable fats are melting in machines and wash programs above 50° C. This makes them relatively simple to emulsify and remove from the surface of tableware.

However at lower temperatures, around 40-45° C. it becomes increasingly difficult to remove such fats, as this temperature may be below their melting point. Solid fats are difficult to remove from the surface of soiled tableware and cutlery as they are difficult to emulsify.

This can lead to unpleasant fatty deposits being left either on the tableware or on the internal surfaces of the dishwasher itself at the end of cleaning cycles when current detergent formulations are used.

It is the object of the present invention to attempt to address this problem.

In a first aspect of the present invention there is provided an automatic dishwashing detergent composition that is suitable for low temperature cleaning wherein the detergent comprises an extract of the soapwort plant.

The applicants have found that small amounts of extracts from the soapwort plant can massively improve the of fat removal performance of detergents at low temperature.

For the purposes of the present invention extracts from the soapwort plant may mean anything from pulped crude parts of the plant to chemicals carefully extracted and purified from the plant parts.

In particular it may mean extracted saponins (for example FIG. 1) or saponarin (FIG. 2) or mixtures of these compounds. These extracts may or may not have been subjected to further purification steps to improve their purity.

Saponaria, also known as soapworts, is a genus of about 20 species of perennial herbs in the Caryophyllaceae plant family, native to southern Europe and southwest Asia

The most familiar species in Europe is the Common Soapwort (S. officinalis), locally simply known as “the Soapwort”. They grow to a height of 10-60 cm, with opposite leaves 1-6 cm long. The flowers are produced in tight clusters on the stem, 4-25 mm diameter, with five white, yellow, pink, or pale purple petals.

The plant is native to temperate regions of Europe, Asia and North America, soapwort thrives in open woodland and on embankments and wasteground. It has been widely cultivated as a garden plant.

Soapworts are cultivated for their attractive flowers; they grow freely in any soil and under most conditions. The crushed leaves or roots of S. officinalis have been used as a soap since the Renaissance.

All parts of soapwort may contain saponins (around 5%), resin and a small quantity of volatile oil.

The saponin from Saponaria officinalis herb is the main compound that is responsible for the detergent-like and emulsifying effects of this plant.

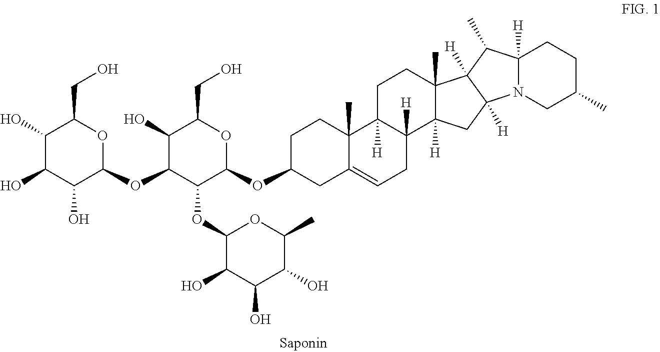

In addition, a saponarin can contribute to the emulsifying effect due to its molecular structure (hydrophilic and lipophilic groups in the molecule).

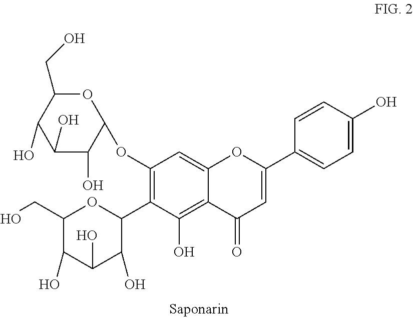

Very small quantities of the soapwort extracts above are especially effective in removing fats at low temperatures.

The extract may be a complicated mixture of compounds from the soapwort plant. The extract may be purified individual compounds, such as the saponin and saponarin in FIGS. 1 and 2 above, or mixtures of the two thereof.

The purity of the extracted compounds may be greater than 60% by weight, preferably 75% by weight and most preferably greater than 90% by weight.

The extract may be used in a highly diluted form. The amount of saponins present in the extract may be between 50 and 5000 ppm, preferably between 100 and 2500 ppm and more preferably between 300 and 700 ppm.

The amount of the soapwort extract in the detergent composition needed to improve the fat removing effects at low temperature may be very low.

The total amount of soapwort plant extract included in the ADW detergent compositions of the present invention may be between 0.0001% and 10% by weight, preferably between 0.01% and 5% by weight and more preferably between 0.1% and 1% by weight.

In a typical detergent composition for an automatic dishwasher (approximate weight of between 17 and 25 grams per dose) the total soapwort plant extract content may be between 0.1 mg and 5 g, preferably between 10 mg and 1 g, more preferably between 20 mg and 500 mg, most preferably between 30 mg and 400 mg.

The detergent composition of the present invention may be a single formulation or be composed of two or more separate formulations. For example a multi-layer tablet. Detergent compositions are often provided as a combination two or more separate formulations to allow for the potentially incompatible reagents (such as enzymes and bleaches) to be stored effectively.

If multiple formulations make up the composition, the soapwort plant extract may be provided in any one of the formulations or all of them.

The detergent composition of the present invention may be effective at removing fats from tableware at wash temperatures less than or equal to 50° C., preferably less than or equal to 45° C. and most preferably less than or equal to 40° C.

By wash temperatures, this means the temperature of the wash liquor attained in the cleaning cycle. The wash temperature does not necessarily include the temperature of the drying portion of the wash cycle, although this is preferable.

The drying temperature used may be above the temperature of the wash temperature.

The detergent compositions of the present invention are particularly effective at removing fats from tableware that have a melting point above that of the wash temperature.

In addition to soapwort extracts above, the detergent compositions of the present invention may comprise other ingredients. These may comprise a wide range of other ingredients. A suitable non limiting example of a detergent composition for use with the soapwort extract will be the Finish® range of dishwasher detergents. A second aspect of the present invention relates to the use of a detergent composition comprising a soapwort extract to clean soiled tableware in an automatic dishwashing machine.

In a further aspect the wash program used on the automatic dishwashing machine preferably has a maximum wash temperature that is less than, or equal to, 50° C., more preferably has a maximum temperature that is less than or equal to 45° C. and most preferably has a maximum temperature that is less than equal to 40° C.

Suitable detergent compositions for use in the present invention may comprise the following ingredients in addition to the soapwort extract:

### BLEACHES

Any conventional bleaching compound can be used in any conventional amount, in either the composition of the invention or in any other detergent composition forming part of a multi-phase unit dose detergent composition.

The bleaching compound may be provided in its active form. However it is preferable that the bleaching compound is provided in a precursor form that breaks down into the active species when required in the cleaning process.

There may be more than one bleaching compound in the detergent compositions of the present invention. A combination of bleaching compounds can be used.

The bleaching compound is preferably present in the relevant detergent composition in an amount of at least 1% by weight, more preferably at least 2% by weight, more preferably at least 4% weight. Preferably it is present in the relevant composition in an amount of up to 30% weight, more preferably up to 25% weight, and most preferably up to 20% by weight.

If more than one bleaching compound is used, the total fraction of bleaching compound is preferably present in the relevant composition in an amount of at least 1% by weight, more preferably at least 2% by weight, more preferably at least 4% weight. Preferably it is present in the relevant composition in an amount of up to 30% weight, more preferably up to 25% weight, and most preferably up to 20% by weight.

The bleach used is preferably an oxygen based bleaching system.

In the detergent compositions of the present invention the bleach compound normally depends on hydrogen peroxide or a hydrogen peroxide precursor such as a percarbonate.

Most preferably the bleach is selected from inorganic peroxy-compounds and organic peracids and the salts derived therefrom.

Examples of inorganic perhydrates include persulfates such as peroxymonopersulfate (such as KMPS), perborates or percarbonates. The inorganic perhydrates are normally alkali metal salts, such as lithium, sodium or potassium salts, in particular sodium salts. The inorganic perhydrates may be present in the detergent as crystalline solids without further protection. For certain perhydrates, it is however advantageous to use them as granular compositions provided with a coating which gives the granular products a longer shelf life.

The preferred percarbonate is sodium percarbonate of the formula 2Na₂CO₃.3H₂O₂. A percarbonate, when present, is preferably used in a coated form to increase its stability.

Organic peracids include all organic peracids traditionally used as bleaches, including, for example, perbenzoic acid and peroxycarboxylic acids such as mono- or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

The pH of the detergent composition may be between 6 and 14, preferably between 8 and 12 and more preferably between 9 and 11.

### BUILDERS

The composition may further comprise one or more builder compounds. These may be selected, for example, from the group comprising sodium tripolyphosphate (STPP), sodium citrate, sodium iminodisuccinate, sodium hydroxyiminodisuccinate, methylglycinediacetic acid (MGDA), and glutamic acid, N,N-diacetic acid (GLDA) or salts or combinations thereof. However the invention is not limited to these builders

A particularly preferred builder is MGDA.

Preferably, the total builder quantity in the detergent composition comprises from 5% to 95% by weight, preferably from 15% to 75% by weight, preferably from 25% to 65% by weight, most preferably from 30% to 60% by weight of the detergent composition.

### OXIDATION CATALYSTS

The compositions of the invention may also include oxidation catalysts.

Some non limiting examples of other oxidation catalysts that may be used in the compositions of the present invention include manganese oxalate, manganese-acetate, manganese-collagen, cobalt-amine catalysts and the Manganese-Triazacyclononane (Mn-TACN) catalyst. The oxidation catalysts may comprise other metal compounds, such as iron or cobalt complexes.

The skilled person will be aware of other oxidation catalysts that may be successfully combined with the detergent compositions of the present invention.

The oxidation catalysts may comprised between 0.005 and 1% by weight of the detergent formulation, preferably between 0.05 and 0.5% by weight, most preferably between 0.1 and 0.3% by weight.

### SURFACTANTS

The detergent compositions of the present invention may comprise surfactants. These are usually non-ionic surfactants.

Non-ionic surfactants are preferred for automatic dishwashing (ADW) detergents since they are defined as low foaming surfactants. The standard non-ionic surfactant structure is based on a fatty alcohol with a carbon C₈ to C₂₀ chain, wherein the fatty alcohol has been ethoxylated or propoxylated. The degree of ethoxylation is described by the number of ethylene oxide units (EO), and the degree of propoxylation is described by the number of propylene oxide units (PO).

The length of the fatty alcohol and the degree of ethoxylation and/or propoxylation determines if the surfactant structure has a melting point below room temperature or in other words if is a liquid or a solid at room temperature.

Surfactants may also comprise butylene oxide units (BO) as a result of butoxylation of the fatty alcohol. Preferably, this will be a mix with PO and EO units. The surfactant chain can be terminated with a butyl (Bu) moiety.

Preferred solid non-ionic surfactants are ethoxylated non-ionic surfactants prepared by the reaction of a mono-hydroxy alkanol with 6 to 20 carbon atoms. Preferably the surfactants have at least 12 moles, particularly preferred at least 16 moles, and still more preferred at least 20 moles, such as at least 25 moles of ethylene oxide per mole of alcohol.

Particularly preferred solid non-ionic surfactants are the non-ionics from a linear chain fatty alcohol with 16-20 carbon atoms and at least 12 moles, particularly preferred at least 16 and still more preferred at least 20 moles, of ethylene oxide per mole of alcohol.

The non-ionic surfactants additionally may comprise propylene oxide units in the molecule. Preferably these PO units constitute up to 25% by weight, preferably up to 20% by weight and still more preferably up to 15% by weight of the overall molecular weight of the non-ionic surfactant.

Surfactants which are ethoxylated mono-hydroxy alkanols which additionally comprise poly-oxyethylene-polyoxypropylene block copolymer units may be used. The alcohol portion of such surfactants constitutes more than 30%, preferably more than 50%, more preferably more than 70% by weight of the overall molecular weight of the non-ionic surfactant.

Another class of suitable non-ionic surfactants includes reverse block copolymers of polyoxyethylene and poly-oxypropylene and block copolymers of polyoxyethylene and polyoxypropylene initiated with trimethylolpropane.

Another preferred class of non-ionic surfactant can be described by the formula:

R₁O[CH₂CH(CH₃)O]ₓ[CH₂CH₂O]_{y}[CH₂CH(OH)R₂]

where R₁ represents a linear or branched chain aliphatic hydrocarbon group with 4-18 carbon atoms or mixtures thereof, R₂ represents a linear or branched chain aliphatic hydrocarbon rest with 2-26 carbon atoms or mixtures thereof, x is a value between 0.5 and 1.5 and y is a value of at least 15.

Another group of preferred non-ionic surfactants are the end-capped polyoxyalkylated non-ionics of formula:

R₁O[CH₂CH(R₃)O]ₓ[CH₂]ₖCH(OH)[CH₂]ⱼOR₂

where R₁ and R₂ represent linear or branched chain, saturated or unsaturated, aliphatic or aromatic hydrocarbon groups with 1-30 carbon atoms, R₃ represents a hydrogen atom or a methyl, ethyl, n-propyl, iso-propyl, n-butyl, 2-butyl or 2-methyl-2-butyl group, x is a value between 1 and 30 and, k and j are values between 1 and 12, preferably between 1 and 5. When the value of x is >2 each R₃ in the formula above can be different. R₁ and R₂ are preferably linear or branched chain, saturated or unsaturated, aliphatic or aromatic hydrocarbon groups with 6-22 carbon atoms, where group with 8 to 18 carbon atoms are particularly preferred. For the group R₃=H, methyl or ethyl are particularly preferred. Particularly preferred values for x are comprised between 1 and 20, preferably between 6 and 15.

As described above, in case x>2, each R₃ in the formula can be different. For instance, when x=3, the group R₃ could be chosen to build ethylene oxide (R₃=H) or propylene oxide (R₃=methyl) units which can be used in every single order for instance (PO)(EO)(EO), (EO)(PO)(EO), (EO)(EO)(PO), (EO)(EO)(EO), (PO)(EO)(PO), (PO)(PO)(EO) and (PO)(PO)(PO). The value 3 for x is only an example and bigger values can be chosen whereby a higher number of variations of (EO) or (PO) units would arise.

Particularly preferred end-capped polyoxyalkylated alcohols of the above formula are those where k=1 and j=1 originating molecules of simplified formula:

R₁O[CH₂CH(R₃)O]ₓCH₂CH(OH)CH₂OR₂

The use of mixtures of different nonionic surfactants is suitable in the context of the present invention for instance mixtures of alkoxylated alcohols and hydroxy group containing alkoxylated alcohols.

Other suitable surfactants are disclosed in WO 95/01416, to the contents of which express reference is hereby made.

In a particularly preferred embodiment of the present invention, the composition according to the first aspect of the present invention is one wherein the liquid non-ionic surfactant has the general formula

R₁-[EO]ₙ-[PO]ₘ-[BO]ₚ-Bu_{q}

wherein:
R₁ is an alkyl group of between C₈ and C₂₀ ;
EO is ethylene oxide;
PO is propylene oxide;
BO is butylene oxide;
Bu is butylene
n and m are integers from 1 to 15;
p is an integer from 0 to 15; and
q is 0 or 1.

Examples of especially preferred nonionic surfactants are the Plurafac™ Lutensol™ and Pluronic™ range from BASF, Dehypon™ series from Cognis and Genapol™ series from Clariant.

The total amount of surfactants typically included in the detergent compositions is in amounts of up to 15% by weight, preferably of from 0.5% to 10% by weight and most preferably from 1% to 5% by weight. These totals are excluding the soapwort extracts.

Preferably non-ionic surfactants are present in the compositions of the invention in an amount of from 0.1% to 5% by weight, more preferably 0.25% to 3% by weight and most preferably 0.5% to 2.5% by weight. These totals are excluding the soapwort extracts.

### BLEACH ACTIVATORS

Generally the use of a bleach activator in a detergent composition can lead to a significant reduction in the effective washing temperature. Compositions of the present invention may also comprise a bleach activator.

If desired therefore, the detergent compositions may comprise one or more additional bleach activators depending upon the nature of the bleaching compound.

Any suitable bleach activator or combination of bleach activators may be included. A non-limiting example of a common bleach activator is tetraacetylethylenediamine (TAED).

Conventional amounts of the bleach activators may be used in the composition of the present invention. The bleach activator may be present in amounts of from 0.5% to 30% by weight, preferably from 1% to 25% by weight and most preferably from 2% to 20% by weight of the detergent composition.

### ENZYMES

The composition may comprise one or more enzymes. Desirably the enzyme is present in the compositions in an amount of from 0.01% to 5% by weight especially 0.01% to 4% by weight, for each type of enzyme when added as a commercial preparation. As they are not 100% active preparations this represents an equivalent amount of 0.005% to 1% by weight of pure enzyme, preferably 0.01% to 0.75% by weight, especially 0.01% to 0.5% by weight of each enzyme used in the compositions. The total amount of enzyme in the detergent composition is preferably in the range of from 0.01% to 6% weight percent, especially 0.01% to 3% by weight, which represents an equivalent amount of 0.01% to 2% by weight of pure enzyme, preferably 0.02% to 1.5% by weight, especially 0.02% to 1% by weight of the total active enzyme used in the compositions.

Any type of enzyme conventionally used in detergent compositions may be used according to the present invention. It is preferred that the enzyme is selected from proteases, lipases, amylases, cellulases, pectinases, laccases, catalases and all oxidases, with proteases, pectinases and amylases, (especially proteases) being most preferred. It is most preferred that protease and/or pectinases and/or amylase enzymes may be included in the compositions according to the invention; such enzymes are especially effective for example in dishwashing detergent compositions. Any suitable species of these enzymes may be used as desired.

### ANTI CORROSION AGENTS

Preferred silver/copper anti-corrosion agents are benzotriazole (BTA) or bis-benzotriazole and substituted derivatives thereof. Other suitable agents are organic and/or inorganic redox-active substances and paraffin oil. Benzotriazole derivatives are those compounds in which the available substitution sites on the aromatic ring are partially or completely substituted. Suitable substituents are linear or branch-chain C₁₋₂₀ alkyl groups and hydroxyl, thio, phenyl or halogen such as fluorine, chlorine, bromine and iodine. A preferred substituted benzotriazole is tolyltriazole.

It is known to include a source of multivalent ions in detergent compositions, and in particular in automatic dishwashing compositions, for anti-corrosion benefits. For example, multivalent ions and especially zinc, bismuth and/or manganese ions have been included for their ability to inhibit such corrosion. Organic and inorganic redox-active substances which are known as suitable for use as silver/copper corrosion inhibitors are mentioned in WO 94/26860 and WO 94/26859. Suitable inorganic redox-active substances are, for example, metal salts and/or metal complexes chosen from the group consisting of zinc, manganese, titanium, zirconium, hafnium, vanadium, cobalt and cerium salts and/or complexes, the metals being in one of the oxidation states II, Ill, IV, V or VI. Particularly suitable metal salts and/or metal complexes are chosen from the group consisting of MnSO₄, Mn(II) citrate, Mn(II) stearate, Mn(II) acetylacetonate, Mn(II) [1-hydroxyethane-1,1-diphosphonate], V₂O₅, V₂O₄, VO₂, TiOSO₄, K₂ZrF₆, CoSO₄, Co(NO₃)₂ and Ce(NO₃)₃. Any suitable source of multivalent ions may be used, with the source preferably being chosen from sulphates, carbonates, acetates, gluconates and metal-protein compounds. Zinc salts are specially preferred glass corrosion inhibitors.

Any conventional amount of the anti-corrosion agents may be included in the compositions of the invention. However, it is preferred that they are present in an total amount of from 0.01% to 5% by weight, preferably 0.05% to 3% by weight, more preferably 0.1% to 2.5% by weight, such as 0.1% to 1% by weight based on the total weight of the composition. If more than one anti-corrosion agent is used, the individual amounts may be within the preceding amounts given but the preferred total amounts still apply.

### FORMAT OF THE COMPOSITION

The detergent composition may take any form known in the art. Possible forms include tablets, powders, gels, pastes and liquids. The detergent compositions may also comprise a mixture of two or more forms. For example the composition may comprise a gel component and a free powder component.

Tablets may be homogeneous of composed of multi-layers. If the tablets are multi-layered then different layers may comprise different parts of the detergent composition. This may be done to increase stability or increase performance, or both. The tablets may have two or more layers. The layers may or may not be equal in volume, mass or dimension.

The detergent compositions may be housed in PVOH rigid capsules or film blisters. These PVOH capsules or blisters may have a single compartment or may be multi-compartment.

Multi-compartment blisters or capsules may have different portions of the composition in each compartment, or the same composition in each compartment. The distinct regions/or compartments may contain any proportion of the total amount of ingredients as desired.

The PVOH capsules or film blisters may be filled with tablets, powders, gels, pastes or liquids, or combinations of these.

The invention is further demonstrated by the following non-limiting examples.

Further examples within the scope of the invention will be apparent to the person skilled in the art.

### Experimental Results

Base formula:

| Ingredients | Formulation |
|---|---|
| Sodium Tri-polyphosphate | 53.0 |
| Sodium carbonate | 15.0 |
| Sodium percarbonate | 15.0 |
| Oxidation catalyst | 0.2 |
| TAED | 3.0 |
| Protease | 1.0 |
| Amylase | 0.5 |
| C₁₆₋₁₈ EO₂₅ | 2.0 |
| Polyethyleneglycol 1500 | 10.0 |
| Tolyltriazole | 0.1 |
| Perfume | 0.1 |
| Colourant | 0.1 |
| Total | 100.0 |

18 grams of the above base formulation was used as a control.

The composition of the present invention that was tested comprised 18 grams of the above base formulation with an additional 30 mg of soapwort extract added. The soapwort extracted used was in a liquid form. The liquid contained 450 ppm of saponarin.

### Test Method

In a Miele 1022 SC Dishwasher the 40° C. Schnell program is used to run a grease removal test at 40° C. with tap water (16 GH).

Four white china plates were used in the test. The soil was Aldi_Bellasan Pflanzenfett (vegetable fat). The fat was dyed with a blue dye for visual analysis. The dye used was Fett Blau B01 L-Nr.: 789.

Firstly the dishes and machine used in the test were cleaned with a machine cleaner using the 75° C. program.

The vegetable fat was then melted at 200° C. and the blue dye added (0.5 weight percent).

0.5g of the melted fat was then spread on each china plate and stored at room temperature for 24 hours.

The plate was then placed in the cleaned machine and washed with the Schnell 40° program.

The amount of the fat left on the plate was then analysed visually and by weight of fat remaining.

The test was repeated four times for the composition of the present invention and four times for the control to gain an average result.

The composition with the soapwort extract of the present invention removed 60% of the grease on the plate. The control composition removed only 50% of the grease on the plate.

### Beaker Test

Further qualitative testing was carried out using a beaker experiment to provide a visual analysis of the effects of the extract.

The test involved adding a detergent solution to a set about of dyed fat in a beaker and visually assessing for emulsification. The tests were carried out at temperatures to simulate an Eco wash setting.

The experimental detail is shown in the table below.

| | |
|---|---|
| Detergent stock solution | 18 grams base formulation/3 L |
| | Tap Water |
| Beaker | Beaker glass 250 ml |
| Detergent solution amount per | 100 ml |
| test | |
| Soil | 1 g HHS soil + |
| | 0.5 ml Sunflower oil (including |
| | 0.5% dye) |
| Amount of soapwort extract to | 5 mg to 1 g added to test solution |
| test | |
| Temperature | 40° C. |
| Stir Rate | 500 rpm |
| Contact Time | 5 minutes |
| Visual Assessment | Emulsification by the formation of |
| | small oil droplets. |

The beaker tests showed that even very small amounts of soapwort caused significant emulsification of the test soil fat samples in comparison with the control base detergent solution alone. Increasing the quantity of soapwort extract used in the tests demonstrated also demonstrated a clear increase in performance.

In addition, further experiments found that the composition of the present invention was at least as good as the base formula in other dishwashing tests, including cleaning and spotting & filming performance tests. Thus there is no detrimental effect of putting the soapwort extract in the detergent composition.

1. An automatic dishwashing detergent composition suitable for low temperature cleaning comprising an extract from the soapwort plant.

2. The automatic dishwashing detergent composition according to claim 1, wherein the extract from the soapwort plant comprises a saponin.

3. The automatic dishwashing detergent composition according to claim 1, wherein the extract from the soapwort plant comprises saponarin.

4. The automatic dishwashing detergent composition according to claim 1, wherein the extract from the soapwort plant is present between 0.005 and 5% by weight of the automatic dishwashing detergent composition.

5. The automatic dishwashing detergent composition according to claim 1 wherein the extract from the soapwort plant is present between 0.01 and 1% by weight of the automatic dishwashing detergent composition.

6. The automatic dishwashing detergent composition according to claim 1, wherein the composition is in the form selected from the group consisting of a compressed tablet, PVOH film gel pack and rigid PVOH capsule.

7. A method of cleaning soiled tableware in an automatic dishwashing machine comprising:
contacting the automatic dishwashing detergent of claim 1 with soiled tableware in an automatic dishwashing machine.

8. The method according to claim 7 further comprising contacting the automatic dishwashing detergent with the soiled tableware during at least a wash program of the automatic dishwashing machine, wherein the wash program has a maximum wash temperature that is less than, or equal to, 50° C.

9. The method according to claim 8, wherein the maximum temperature of the wash cycle is less than or equal to 45° C.

10. The method according to claim 9, wherein the maximum temperature of the wash cycle is less than or equal to 40° C.

11. The automatic dishwashing detergent composition according to claim 1 further comprising a bleaching compound.

12. The automatic dishwashing detergent composition according to claim 1 further comprising a builder compound.

13. The automatic dishwashing detergent composition according to claim 1 further comprising an oxidation catalyst.

14. The automatic dishwashing detergent composition according to claim 1 further comprising a surfactant.

15. The automatic dishwashing detergent composition according to claim 1 further comprising a bleach activator.

16. The automatic dishwashing detergent composition according to claim 1 further comprising an enzyme.

17. The automatic dishwashing detergent composition according to claim 1 further comprising an anti-corrosion agent.

18. The automatic dishwashing detergent composition according to claim 1 further comprising an anti-corrosion agent.

19. The automatic dishwashing detergent composition according to claim 1 further comprising:
a bleaching compound;
a builder compound;
an oxidation catalyst;
a surfactant;
a bleach activator;
an enzyme; and
an anti-corrosion agent.
